(19) United States
(12) Patent Application Publication
(10) Pub. No.: US 2024/0254795 A1
(43) Pub. Date: Aug. 1, 2024

(54) POOL CLEANING ROBOT AND CONTROL METHOD THEREOF

(71) Applicant: Shenzhen Seauto Technology Co., Ltd., Shenzhen, Guangdong (CN)

(72) Inventor: ZHUOMING DENG, Shenzhen (CN)

(21) Appl. No.: 17/923,897

(22) PCT Filed: Sep. 13, 2022
(86) PCT No.: PCT/CN2022/118363

§ 371 Date: Nov. 7, 2022

(30) Foreign Application Priority Data
Aug. 25, 2022 (CN) 202211029919.4

(51) Int. Cl. E04H 4/16

(52) U.S. Cl. CPC E04H 4/1654

(57) ABSTRACT

The present disclosure provides a pool cleaning robot and control method thereof, the pool cleaning robot including: a vehicle body, a sensor, a first electric motor and a second electric motor, a water suction port provided at a bottom part of the vehicle body, a first water outlet communicated with the water suction port provided rearward along a horizontal direction at a rear part of the vehicle body, a second water outlet communicated with the water suction port provided vertically upward at a top part of the vehicle body, and the sensor arranged at a front part of the vehicle body for detecting a motion state of the vehicle body; the first electric motor configured to control the first water outlet to drain water when the sensor detects that the vehicle body is in a first motion state; the second electric motor configured to control the second water outlet to drain water when the sensor detects that the vehicle body is in a second motion state. Comparing to the prior art, the present disclosure increases the motion stability of the pool cleaning robot and improves the cleaning efficiency and cleaning effect.

### CROSS-REFERENCE TO RELATED APPLICATIONS

The present application is a national phase application of PCT Application No. PCT/CN2022/118363, filed Sep. 13, 2022, entitled “POOL CLEANING ROBOT AND CONTROL METHOD THEREOF”, which claims the benefit of Chinese Patent Application No. 202211029919.4, filed Aug. 25, 2022, each of which is incorporated by reference in its entirety.

### TECHNICAL FIELD

The present disclosure relates to the art of robot technology, and in particular relates to a pool cleaning robot and control method thereof.

### BACKGROUND ART

At present, swimming pool cleaning is usually divided into two categories, one is to filter the water quality of the swimming pool by water filtration machines, and the other is to clean the dirt on the bottom and sidewalls of the swimming pool by robot. Wherein, the current technical solution adopted by the robot for cleaning the dirt on the bottom and sidewalls of the swimming pool is to arrange a water suction port at the bottom part of the robot, and arrange a water outlet at the obliquely rear side on the top, and by absorbing water through the water suction port, the robot is adsorbed on the bottom or sidewall of the swimming pool, meanwhile the water outlet arranged at the upper inclined side spray water obliquely upward, thus the reaction force of the water provides auxiliary power for the robot to move forward close to the bottom or sidewall of the swimming pool.

However, the reaction force generated by the obliquely upward spraying water can be decomposed into forces in two directions, which are the pressure of the pool cleaning robot on the bottom or sidewall of the swimming pool, and the driving force for the pool cleaning robot to move forward, when there is an obstacle at the bottom of the swimming pool, or the robot climbs along the sidewall of the swimming pool to a certain angle, due to the force component, the robot cannot stick to the bottom or sidewall of the swimming pool, the wheels of the robot idling, and the power is insufficient to have the robot moving forward.

### SUMMARY OF DISCLOSURE

The main propose of the present disclosure is to solve the technical problems above, providing a pool cleaning robot and control method thereof.

To achieve the above purpose, the present disclosure provides a pool cleaning robot, including: a vehicle body, a sensor, a first electric motor, and a second electric motor, a water suction port provided at a bottom part of the vehicle body, a first water outlet communicated with the water suction port provided rearward along a horizontal direction at a rear part of the vehicle body, a second water outlet communicated with the water suction port provided vertically upward at a top part of the vehicle body, and the sensor arranged at a front part of the vehicle body for detecting a motion state of the vehicle body;

the first electric motor configured to control the first water outlet to drain water when the sensor detects that the vehicle body is in a first motion state;

the second electric motor configured to control the second water outlet to drain water when the sensor detects that the vehicle body is in a second motion state.

A further technical solution of the present disclosure is that the first motion state includes a distance between the vehicle body and an obstacle in front of the vehicle body being less than or equal to a preset distance, and when the distance between the vehicle body and the obstacle in front of the vehicle body is less than or equal to the preset distance, the first electric motor starts to control the first water outlet to drain water backwards.

A further technical solution of the present disclosure further includes a wheel arranged on the bottom part of the vehicle body, the first motion state further includes the wheel being in an idling state, and when the wheel is in an idling state, the first electric motor starts to control the first water outlet to drain water backwards.

A further technical solution of the present disclosure is that the second motion state includes an angle between the vehicle body and the sidewall of the swimming pool being less than or equal to a preset angle, and when the angle between the vehicle body and the sidewall of the swimming pool is less than or equal to the preset angle, the second electric motor starts to control the second water outlet to drain water upwards.

A further technical solution of the present disclosure is that the first water outlet is communicated with the water suction port through a first water conduit, and the first electric motor is arranged inside the first water conduit, the pool cleaning robot further including a first screw propeller arranged inside the first water conduit and connected with an output shaft of the first electric motor;

the second water outlet is communicated with the water suction port through a second water conduit, and the second electric motor is arranged inside the second water conduit, the pool cleaning robot further including a second screw propeller arranged inside the second water conduit and connected with an output shaft of the second electric motor;
the pool cleaning robot further includes a controller connected with the sensor, the first electric motor, and the second electric motor, the controller is configured to control the start of the first electric motor and/or the second electric motor to drive the first screw propeller and/or the second screw propeller rotate, thereby controlling the first water outlet and/or the second water outlet to drain water.

A further technical solution of the present disclosure is that the first water conduit is provided with a one-way valve at the position corresponding to the first water outlet; the bottom part of the vehicle body is provided with a filter screen in the position of the water suction port.

In order to achieve the above purpose, the present disclosure also provides a control method for a pool cleaning robot. The method is applied to the pool cleaning robot as described above, wherein comprises the following steps:
after the pool cleaning robot starts, the sensor detects the motion state of the vehicle body;
when the motion state of the vehicle body is a first motion state, the first electric motor controls the first water outlet to drain water; when the motion state of the body is a second motion state, the second electric motor controls the second water outlet to drain water.

A further technical solution of the present disclosure is that the first motion state includes a distance between the vehicle body and the obstacle in front of the vehicle body being less than or equal to a preset distance, the steps that the first electric motor controls the first water outlet to drain water when the motion state of the vehicle body is a first motion state include:
controlling the first water outlet to drain water by the first electric motor when the distance between the vehicle body and the obstacle in front of the vehicle body is less than or equal to a preset distance.

A further technical solution of the present disclosure is that the first motion state further includes the wheel being in an idling state, the steps that the first electric motor controls the first water outlet to drain water when the motion state of the vehicle body is the first motion state include:
controlling the first water outlet to drain water by the first electric motor when the wheel is in an idling state.

A further technical solution of the present disclosure is that the second motion state includes the angle between the vehicle body and the sidewall of the swimming pool being less than or equal to a preset angle, the steps that the second electric motor controls the second water outlet to drain water when the motion state of the vehicle body is a second motion state include:
controlling the second water outlet to drain water by the second electric motor when the angle between the vehicle body and the sidewall of the swimming pool is less than or equal to a preset angle.

The beneficial effects of the present disclosure of a pool cleaning robot and control method thereof are as follow: Through the above technical solutions, including: a vehicle body, a sensor, a first electric motor, and a second electric motor, a water suction port provided at a bottom part of the vehicle body, a first water outlet communicated with the water suction port provided rearward along a horizontal direction at a rear part of the vehicle body, a second water outlet communicated with the water suction port provided vertically upward at a top part of the vehicle body, and the sensor arranged at a front part of the vehicle body for detecting a motion state of the vehicle body; the first electric motor configured to control the first water outlet to drain water when the sensor detects that the vehicle body is in a first motion state; the second electric motor configured to control the second water outlet to drain water when the sensor detects that the vehicle body is in a second motion state, the motion stability of the pool cleaning robot is increased, and the cleaning efficiency and cleaning effect are improved.

### BRIEF DESCRIPTION OF DRAWINGS

Hereinafter, in order to more clearly explain the embodiments of the present disclosure or the technical solutions in the prior art, the drawings needed to be used in the embodiments or the prior art description will be described briefly. Obviously, the drawings in the following description are only partial embodiments of the present disclosure. Without creative efforts, those people skilled in the art can also obtain other drawings according to the structures shown in these drawings.

FIG. 1 illustrates an overall structure diagram of a preferred embodiment of the pool cleaning robot of the present disclosure;

FIG. 2 is a sectional view of a preferred embodiment of the pool cleaning robot of the present disclosure;

FIG. 3 is a top plan view of a preferred embodiment of the pool cleaning robot of the present disclosure;

FIG. 4 is a right side view of a preferred embodiment of the pool cleaning robot of the present disclosure;

FIG. 5 is a bottom plan view of a preferred embodiment of the pool cleaning robot of the present disclosure;

FIG. 6 is a front view of a preferred embodiment of the pool cleaning robot of the present disclosure;

FIG. 7 is an overall process diagram of a preferred embodiment of the control method of the pool cleaning robot of the present disclosure.

### REFERENCE SIGNS IN THE FIGURES

Vehicle body 10; first electric motor 20; second electric motor 30; water suction port 40; first water outlet 50; second water outlet 60; wheel 70; first water conduit 80; first screw propeller 90; second water conduit 100; second screw propeller 110.

The implementation, functional features and advantages of the present disclosure will be further described by way of embodiment, with reference to the attached figures.

### DESCRIPTION OF EMBODIMENTS

Hereinafter, the technical solutions in the embodiments of the present disclosure will be described clearly and completely with reference to the drawings of the embodiments of the present disclosure. Obviously, the embodiments described are only partial embodiments of the present disclosure, rather than all of the embodiments. Based on the embodiments of the present disclosure, all other embodiments obtained by those skilled in the art without creative efforts all belong to the scope of protection of the present disclosure.

The present disclosure provides a pool cleaning robot, using for cleaning the dirt in the bottom or sidewall of the swimming pool.

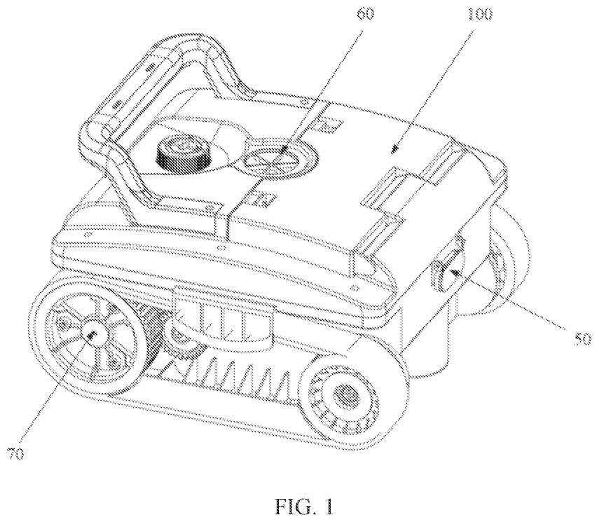

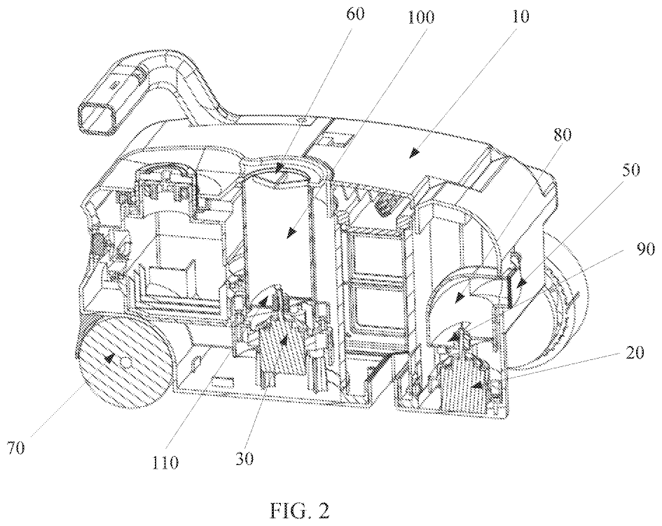

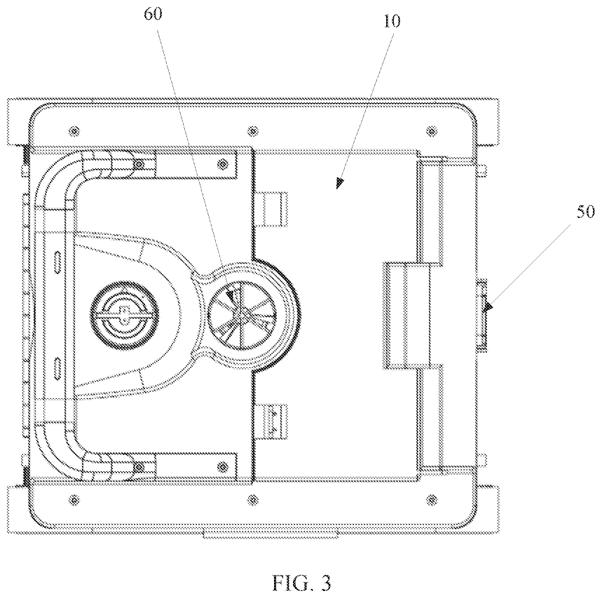

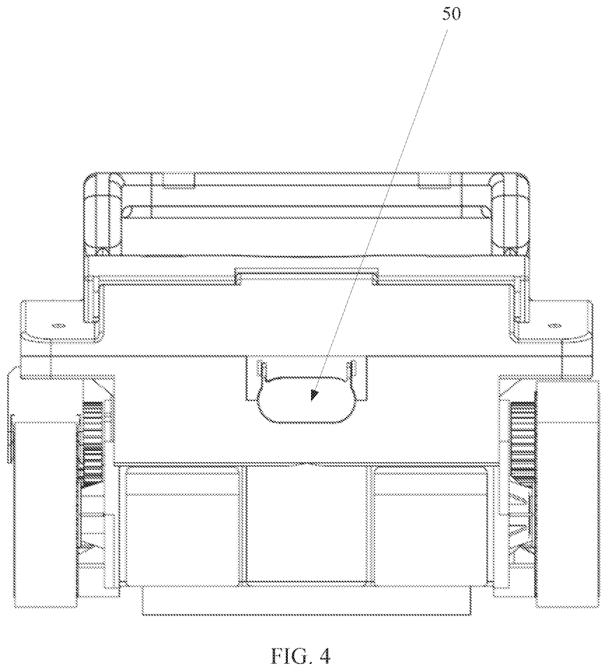

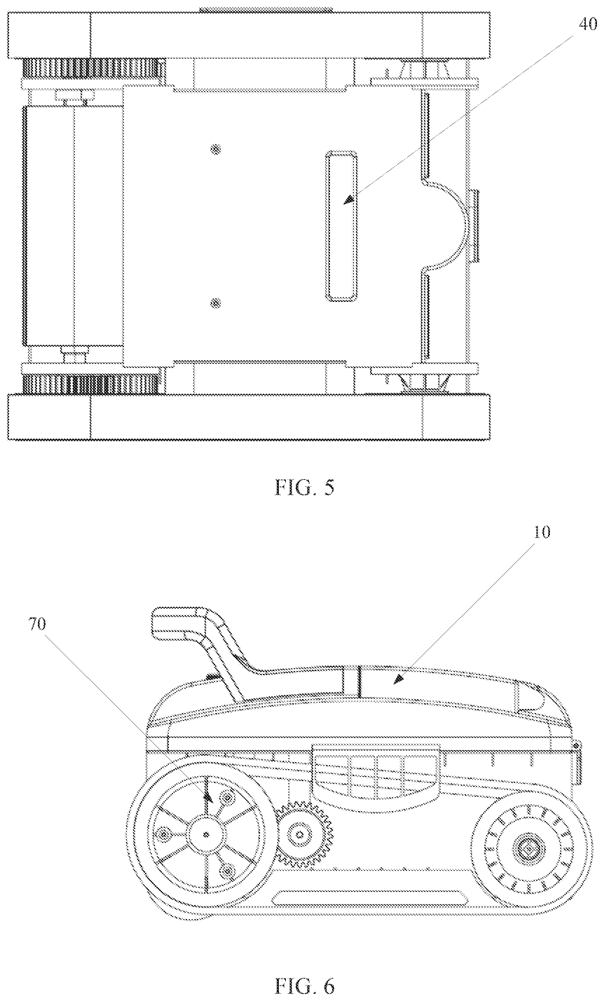

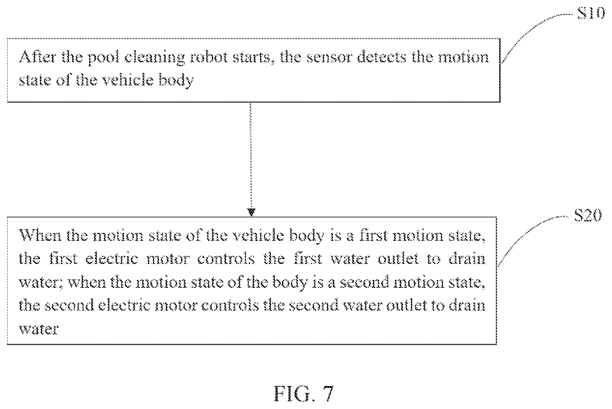

Referring to FIGS. 1-6, a preferred embodiment of the pool cleaning robot of the present disclosure includes a vehicle body 10, a sensor (not shown in the drawings), a first electric motor 20 and a second electric motor 30, a water suction port 40 provided at a bottom part of the vehicle body 10, a first water outlet 50 communicated with the water suction port 40 provided rearward along a horizontal direction at a rear part of the vehicle body 10, a second water outlet 60 communicated with the water suction port 40 provided vertically upward at a top part of the vehicle body 10, and the sensor is arranged at a front part of the vehicle body 10 for detecting the motion state of the vehicle body 10.

It should be noted that, in this embodiment, by absorbing the water in the swimming pool through the water suction port 40, an adsorption force can be provided between the pool cleaning robot and the bottom or sidewall of the swimming pool, and when the water is drained through the first water outlet 50, the reaction force generated thereout can provide power for the pool cleaning robot to move forward, and when the water is drained through the second water outlet 60, the reaction force generated thereout can increase the pressure of the vehicle body 10 on the sidewall or bottom of the swimming pool, thereby preventing the wheel 70 from idling, and ensuring that the pool cleaning robot can climb to the sidewall of the swimming pool for cleaning.

In the present embodiment, the motion state of the vehicle body 10 includes a first motion state and a second motion state, wherein the first motion state includes a distance between the vehicle body 10 and the obstacle in front of the vehicle body 10 being less than or equal to a preset distance, or the wheel 70 of the vehicle body 10 being in an idling state, the first electric motor 20 configured to control the first water outlet 50 to drain water when the sensor detects that the vehicle body 10 is in the first motion state.

The preset distance can be set according to actual needs, for example, 1 meter, 0.5 meter, etc., which is not limited in this embodiment. In this embodiment, the obstacle can be, for example, a floor drain at the bottom of the swimming pool, a sidewall of the swimming pool, etc.

As an implementation, the sensor can be sonar sensor or other distance sensor to detect the distance between the vehicle body 10 and the obstacles in front of the vehicle body 10. An IMU tri-axis sensor, or the combination of an angular rate sensor and a displacement sensor, can be used to determine whether the wheel 70 is idling. For example, when the wheel 70 is detected to be rotating, while the vehicle body 10 does not generate forwardly displacement, that is, not moving forward, the wheel 70 is determined to be idling and in an idling state. It is not limited in the present disclosure that all sensors can detect the distance between the vehicle body 10 and the obstacles in front of the vehicle body 10 and can determine whether the wheel 70 is idling can be applied in the present disclosure.

When the distance between the vehicle body 10 and the obstacle in front of the vehicle body 10 is less than or equal to the preset distance, or when the wheel 70 is in the idling state, the first electric motor 20 controls the first water outlet 50 to drain water, increasing power for the pool cleaning vehicle to move forward. When the wheel 70 at the front side of the pool cleaning vehicle contacting with the sidewall of the swimming pool, it climbs up along the sidewall of the swimming pool to clean the sidewall of the swimming pool.

The second motion state includes an angle between the vehicle body 10 and the sidewall of the swimming pool being less than or equal to a preset angle, the second electric motor 30 configured to control the second water outlet 60 to drain water when the sensor detects that the vehicle body 10 is in the second motion state.

As an implementation, the sensor can adopt an angle sensor to detect the preset angle between the vehicle body 10 and the sidewall of the swimming pool. The preset angle can be preset according to the actual experience value, such as 45°, which is not limited in this embodiment.

Taking 45° as an example, when the angle between the vehicle body 10 and the sidewall of the swimming pool is 45°, the pressure of the vehicle body 10 on the sidewall of the swimming pool decreases, at this time, the wheel 70 will idle, causing the pool cleaning robot to be unable to continue climbing along the sidewall of the swimming pool. Therefore, at this time, the second electric motor 30 starts to control the second water outlet 60 to drain water, and the pressure of the vehicle body 10 on the sidewall of the swimming pool is increased through the reaction force of water, so that the pool cleaning robot can continue to climb and clean the sidewall of the swimming pool.

Furthermore, in this embodiment, the first water outlet 50 is communicated with the water suction port 40 through a first water conduit 80, and the first electric motor 20 is arranged inside the first water conduit 80, the pool cleaning robot further including a first screw propeller 90 arranged inside the first water conduit 80 and connected with an output shaft of the first electric motor 20.

The second water outlet 60 is communicated with the water suction port 40 through a second water conduit 100, and the second electric motor 30 is arranged inside the second water conduit 100, the pool cleaning robot further including a second screw propeller 110 arranged inside the second water conduit 100 and connected with an output shaft of the second electric motor 30.

The pool cleaning robot further includes a controller (not shown in the drawings) connected with the sensor, the first electric motor 20, and the second electric motor 30, the controller is configured to control the start of the first electric motor 20 and/or the second electric motor 30 to drive the first screw propeller 90 and/or the second screw propeller 110 rotate, thereby controlling the first water outlet 50 and/or the second water outlet 60 to drain water.

Specifically, when the sensor detects that the vehicle body 10 is in the first motion state and send the message of the first motion state to the controller, the controller controls the first electric motor 20 to start to drive the first screw propeller 90 to rotate, thereby controlling the second water outlet 60 to drain water.

When the sensor detects that the vehicle body 10 is in the second motion state and send the message of the second motion state to the controller, the controller controls the second motor 30 to start to drive the second screw propeller 110 to rotate, thereby controlling the second water outlet 60 to drain water.

Furthermore, in this embodiment, the first water conduit 80 is provided with a one-way valve at the position corresponding to the first water outlet 50.

It is worth mentioning that in this embodiment, since the second water outlet 60 is set vertically upward, when the second electric motor 30 starts, and water drained through the second water outlet 60, the one-way valve can be closed to increase the adsorption force to the bottom or sidewall of the swimming pool generated when the second motor 30 drives the second screw propeller 110 to move, thus better preventing the wheel 70 from idling, and further improving the motion stability of the pool cleaning robot.

Furthermore, in this embodiment, the bottom part of the vehicle body 10 is provided with a filter screen in the position of the water suction port 40.

In this embodiment, by providing the filter screen in the position of the water suction port 40 at the bottom part of the vehicle body 10, it is able to prevent the sand, hair, dirt, etc. in the swimming pool from entering the first water conduit 80 and the second water conduit 100 to damage the first electric motor 20, the second electric motor 30, the first screw propeller 90, the second screw propeller 110, and other components, and improve the service life of the pool cleaning robot.

The beneficial effects of the present disclosure of the pool cleaning robot and control method thereof are as follows: Through the above technical solutions, including: a vehicle body, a sensor, a first electric motor, and a second electric motor, a water suction port provided at a bottom part of the vehicle body, a first water outlet communicated with the water suction port provided rearward along a horizontal direction at a rear part of the vehicle body, a second water outlet communicated with the water suction port provided vertically upward at a top part of the vehicle body, and the sensor arranged at a front part of the vehicle body for detecting a motion state of the vehicle body; the first electric motor configured to control the first water outlet to drain water when the sensor detects that the vehicle body is in a first motion state; the second electric motor configured to control the second water outlet to drain water when the sensor detects that the vehicle body is in a second motion state, the motion stability of the pool cleaning robot is increased, and the cleaning efficiency and cleaning effect are improved.

In order to achieve the above purpose, the present disclosure also provides a control method for a pool cleaning robot. The method is applied to the pool cleaning robot as described above.

As shown in FIG. 7, a preferred embodiment of the control method for the pool cleaning robot of the present disclosure includes:
S10, after the pool cleaning robot starts, the sensor detects the motion state of the vehicle body.
S20, when the motion state of the vehicle body is a first motion state, the first electric motor controls the first water outlet to drain water; when the motion state of the body is a second motion state, the second electric motor controls the second water outlet to drain water.

Specifically, the first motion state includes the distance between the vehicle body and the obstacle in front of the vehicle body being less than or equal to a preset distance, the steps that the first electric motor controls the first water outlet to drain water when the motion state of the vehicle body is a first motion state include:
controlling the first water outlet to drain water by the first electric motor when the distance between the vehicle body and the obstacle in front of the vehicle body is less than or equal to a preset distance.

The first motion state includes the wheel being in an idling state, the steps that the first electric motor controls the first water outlet to drain water when the motion state of the vehicle body is the first motion state include:
controlling the first water outlet to drain water by the first electric motor when the wheel is in an idling state.

In this embodiment, the preset distance can be set according to actual needs, for example, 1 meter, 0.5 meter, etc., which is not limited in this embodiment. In this embodiment, the obstacle can be, for example, a floor drain at the bottom of the swimming pool, a sidewall of the swimming pool, etc.

As an implementation, the sensor can be distance sensor to detect the distance between the vehicle body and the obstacle in front of the vehicle body. The combination of an angular rate sensor and a displacement sensor can be used to determine whether the wheel is idling. For example, when the wheel is detected to be rotating, while the vehicle body does not generate forwardly displacement, that is, not moving forward, the wheel is determined to be idling and in an idling state.

When the distance between the vehicle body and the obstacle in front of the vehicle body is less than or equal to the preset distance, or when the wheel is in the idling state, the first electric motor controls the first water outlet to drain water, increasing power for the pool cleaning vehicle to move forward. When the wheel at the front side of the pool cleaning vehicle contacting with the sidewall of the swimming pool, it climbs up along the sidewall of the swimming pool to clean the sidewall of the swimming pool.

The second motion state includes the angle between the vehicle body and the sidewall of the swimming pool being less than or equal to a preset angle, the steps that the second electric motor controls the second water outlet to drain water when the motion state of the vehicle body is a second motion state include:
controlling the second water outlet to drain water by the second electric motor when the angle between the vehicle body and the sidewall of the swimming pool is less than or equal to a preset angle.

As an implementation, the sensor can adopt an angle sensor to detect the preset angle between the vehicle body and the sidewall of the swimming pool. The preset angle can be preset according to the actual experience value, such as 45°, which is not limited in this embodiment.

Taking 45° as an example, when the angle between the vehicle body and the sidewall of the swimming pool is 45°, the pressure of the vehicle body on the sidewall of the swimming pool decreases, at this time, the wheel will idle, causing the pool cleaning robot to be unable to continue climbing along the sidewall of the swimming pool. Therefore, at this time, the second electric motor starts to control the second water outlet to drain water, and the pressure of the vehicle body on the sidewall of the swimming pool is increased through the reaction force of water, so that the pool cleaning robot can continue to climb and clean the sidewall of the swimming pool.

The beneficial effects of the present disclosure of the pool cleaning robot and control method thereof are as follow: Through the above technical solutions, after the pool cleaning robot start, the sensor detects the motion state of the vehicle body; when the motion state of the vehicle body is a first motion state, the first electric motor controls the first water outlet to drain water, when the motion state of the body is a second motion state, the second electric motor controls the second water outlet to drain water. It increases the motion stability of the pool cleaning robot, and improves the cleaning efficiency and cleaning effect.

The foregoing description is merely a preferred detailed implementation of the present disclosure, but the scope of protection of the present disclosure is not limited thereto. Under the conception of the present disclosure, any equivalent structural transformations made by the contents of the description and drawings of the present disclosure, or directly/indirectly applied to other relative technical fields are covered within the scope of protection of the present disclosure.

1. A pool cleaning robot, comprising: a vehicle body, a sensor, a first electric motor, and a second electric motor, a water suction port provided at a bottom part of the vehicle body, a first water outlet communicated with the water suction port provided rearward along a horizontal direction at a rear part of the vehicle body, a second water outlet communicated with the water suction port provided vertically upward at a top part of the vehicle body, and the sensor arranged at a front part of the vehicle body for detecting a motion state of the vehicle body;
the first electric motor configured to control the first water outlet to drain water when the sensor detects that the vehicle body is in a first motion state;
the second electric motor configured to control the second water outlet to drain water when the sensor detects that the vehicle body is in a second motion state.

2. The pool cleaning robot according to claim 1, wherein the first motion state includes a distance between the vehicle body and an obstacle in front of the vehicle body being less than or equal to a preset distance, and when the distance between the vehicle body and the obstacle in front of the vehicle body is less than or equal to the preset distance, the first electric motor starts to control the first water outlet to drain water backwards.

3. The pool cleaning robot according to claim 1, wherein further comprises a wheel arranged on the bottom part of the vehicle body, the first motion state further includes the wheel being in an idling state, and when the wheel is in an idling state, the first electric motor starts to control the first water outlet to drain water backwards.

4. The pool cleaning robot according to claim 1, wherein the second motion state includes an angle between the vehicle body and the sidewall of the swimming pool being less than or equal to a preset angle, and when the angle between the vehicle body and the sidewall of the swimming pool is less than or equal to a preset angle, the second electric motor starts to control the second water outlet to drain water upwards.

5. The pool cleaning robot according to claim 1, wherein the first water outlet is communicated with the water suction port through a first water conduit, and the first electric motor is arranged inside the first water conduit, the pool cleaning robot further including a first screw propeller arranged inside the first water conduit and connected with an output shaft of the first electric motor;
the second water outlet is communicated with the water suction port through a second water conduit, and the second electric motor is arranged inside the second water conduit, the pool cleaning robot further comprising a second screw propeller arranged inside the second water conduit and connected with an output shaft of the second electric motor;
the pool cleaning robot further comprises a controller connected with the sensor, the first electric motor, and the second electric motor, the controller is configured to control the start of the first electric motor and/or the second electric motor to drive the first screw propeller and/or the second screw propeller rotate, thereby controlling the first water outlet and/or the second water outlet to drain water.

6. The pool cleaning robot according to claim 5, wherein the first water conduit is provided with a one-way valve at the position corresponding to the first water outlet; the bottom part of the vehicle body is provided with a filter screen in the position of the water suction port.

7. A control method for pool cleaning robot, wherein the method is applied to the pool cleaning robot according to claim 1, comprising:
detecting the motor state of the vehicle body by the sensor after the pool cleaning robot starts;
controlling the first water outlet to drain water by the first electric motor when the vehicle body is in the first motion state; controlling the second water outlet to drain water by the second electric motor when the body is in the second motion state.

8. The control method for pool cleaning robot according to claim 7, wherein the first motion state includes a distance between the vehicle body and the obstacle in front of the vehicle body being less than or equal to a preset distance, the steps that the first electric motor controls the first water outlet to drain water when the motion state of the vehicle body is a first motion state include:
controlling the first water outlet to drain water by the first electric motor when the distance between the vehicle body and the obstacle in front of the vehicle body is less than or equal to a preset distance.

9. The control method for pool cleaning robot according to claim 7, wherein the first motion state includes the wheel being in an idling state, the steps that the first electric motor controls the first water outlet to drain water when the motion state of the vehicle body is the first motion state include:
controlling the first water outlet to drain water by the first electric motor when the wheel is in an idling state.

10. The control method for pool cleaning robot according to claim 7, wherein the second motion state includes the angle between the vehicle body and the sidewall of the swimming pool being less than or equal to a preset angle, the steps that the second electric motor controls the second water outlet to drain water when the motion state of the vehicle body is a second motion state include:
controlling the second water outlet to drain water by the second electric motor when the angle between the vehicle body and the sidewall of the swimming pool is less than or equal to a preset angle.

11. The pool cleaning robot according to claim 2, wherein the first water outlet is communicated with the water suction port through a first water conduit, and the first electric motor is arranged inside the first water conduit, the pool cleaning robot further including a first screw propeller arranged inside the first water conduit and connected with an output shaft of the first electric motor;
the second water outlet is communicated with the water suction port through a second water conduit, and the second electric motor is arranged inside the second water conduit, the pool cleaning robot further comprising a second screw propeller arranged inside the second water conduit and connected with an output shaft of the second electric motor;
the pool cleaning robot further comprises a controller connected with the sensor, the first electric motor, and the second electric motor, the controller is configured to control the start of the first electric motor and/or the second electric motor to drive the first screw propeller and/or the second screw propeller rotate, thereby controlling the first water outlet and/or the second water outlet to drain water.

12. The pool cleaning robot according to claim 3, wherein the first water outlet is communicated with the water suction port through a first water conduit, and the first electric motor is arranged inside the first water conduit, the pool cleaning robot further including a first screw propeller arranged inside the first water conduit and connected with an output shaft of the first electric motor;
the second water outlet is communicated with the water suction port through a second water conduit, and the second electric motor is arranged inside the second water conduit, the pool cleaning robot further comprising a second screw propeller arranged inside the second water conduit and connected with an output shaft of the second electric motor;
the pool cleaning robot further comprises a controller connected with the sensor, the first electric motor, and the second electric motor, the controller is configured to control the start of the first electric motor and/or the second electric motor to drive the first screw propeller and/or the second screw propeller rotate, thereby controlling the first water outlet and/or the second water outlet to drain water.

13. The pool cleaning robot according to claim 4, wherein the first water outlet is communicated with the water suction port through a first water conduit, and the first electric motor is arranged inside the first water conduit, the pool cleaning robot further including a first screw propeller arranged inside the first water conduit and connected with an output shaft of the first electric motor;
the second water outlet is communicated with the water suction port through a second water conduit, and the second electric motor is arranged inside the second water conduit, the pool cleaning robot further comprising a second screw propeller arranged inside the second water conduit and connected with an output shaft of the second electric motor;
the pool cleaning robot further comprises a controller connected with the sensor, the first electric motor, and the second electric motor, the controller is configured to control the start of the first electric motor and/or the second electric motor to drive the first screw propeller and/or the second screw propeller rotate, thereby controlling the first water outlet and/or the second water outlet to drain water.
